(19) United States
(12) Patent Application Publication
(10) Pub. No.: US 2007/0206001 A1
(43) Pub. Date: Sep. 6, 2007

(54) INTERACTIVE ELECTRONIC DIRECTORY SERVICE, PUBLIC INFORMATION AND GENERAL CONTENT DELIVERY SYSTEM AND METHOD

(75) Inventor: Brent McKay, Newport Beach, CA (US)

Correspondence Address: KNOBBE MARTENS OLSON & BEAR LLP, 2040 MAIN STREET, FOURTEENTH FLOOR, IRVINE, CA, 92614, US

(73) Assignee: eMine Technology, Inc., Newport Beach, CA (US)

(21) Appl. No.: 11/670,374

(22) Filed: Feb. 1, 2007

Related U.S. Application Data
(63) Continuation of application No. 09/943,585, filed on Aug. 30, 2001, now abandoned.
(60) Provisional application No. 60/229,556, filed on Aug. 30, 2000.
(60) Provisional application No. 60/244,761, filed on Oct. 31, 2000.

(51) Int. Cl. G06T 1/00; G09G 3/00; G09G 3/10

(52) U.S. Cl. 345/418; 345/30; 345/37

(57) ABSTRACT

The present invention might is a large-screen electronic building directory system that also integrates advertising and non-commercial content and is positioned and deployed in various public spaces, such as commercial building lobbies, indoor shopping malls, airports or other commercial and transportation hubs. The system combines facility directory, facility services information, concessionaires and advertising sponsor information in a user interface suitable for use in the target environment. A self contained, computer integrated plasma display has a 16:9 aspect ratio and is subdivided into a 14:9 media window portion and a 2:9 control portion. Interaction is through touch-sensitive panel sections. Content establishment and updating is effected through a wide area network communication interface, which also supports bi-directional videophone communication between a system user and offsite service providers. The system is configured to be mounted on the exterior surface of a public space wall, and protrude no further than 4.0 inches from the wall in conformance with ADA building code requirements.

### CROSS REFERENCE TO RELATED APPLICATIONS

This application is a continuation of U.S. patent application Ser. No. 09/943,585, filed Aug. 30, 2001, entitled INTERACTIVE ELECTRONIC DIRECTORY SERVICE, PUBLIC INFORMATION AND GENERAL CONTENT DELIVERY SYSTEM AND METHOD, which claims the benefit of U.S. Provisional Patent Application entitled INTERACTIVE ELECTRONIC DIRECTORY SERVICE, PUBLIC INFORMATION AND GENERAL CONTENT DELIVERY SYSTEM AND METHOD, Ser. No. 60/229,556 filed Aug. 30, 2000 and U.S. Provisional Patent Application entitled INTERACTIVE MEDIA MANAGEMENT SYSTEM AND METHOD FOR NETWORK APPLICATIONS, Ser. No. 60/244,761 filed Oct. 31, 2000, all of which are commonly owned by the assignee of the present invention, the disclosures of which are expressly incorporated herein by reference.

### FIELD OF THE INVENTION

The present invention is directed to systems and methods for providing directed informational media content and, more particularly, to a network-based electronic advertising and informational services architecture adapted for multi-tenant building and campus applications, and other public areas of commercial properties in general.

### BACKGROUND OF THE INVENTION

Recent years have seen considerable advances in the dynamic information presentation marketplace, particularly when coupled with dynamic advertising systems. Conventionally, the dynamic advertising market uses electronic displays to deliver advertising messages and other information in public spaces such as regional malls, airports or other transportation terminals, retail stores and commercial buildings. From an advertising perspective, these spaces have always been of great interest, in that a large number of potential advertising sites and high traffic volumes translates to a very large number of potential customers. Additionally, a proximity to point-of-purchase gives public space venues a high degree of desirability. Historically, public space advertising of any kind has been limited because of resistance by property owners or managers, to advertising display systems that do not deliver sufficient counter-balancing value in the form of public service information. It is perceived that strict advertising presentation tends to degrade the image of the property or facility and, hence, its value or utility.

The issue of unitary content has retarded the development of dynamic advertising systems primarily due to various psychological filters that are set up within the minds of viewers. Those persons not interested in advertising tend to focus their attention elsewhere and not be captured by the message. It is relatively rare that a passerby will initiate interactive contact with a dynamic advertising system unless contact is initiated for other reasons and the dynamic advertising content is delivered along with a certain set of desired information.

A further disadvantage of conventional dynamic advertising systems applies equally to conventional systems for focused content delivery. These disadvantages pertain mainly to the amount of valuable space that must be taken up by a display system footprint. Most systems currently deployed utilize the “kiosk” concept in which content delivery displays are arranged on the faces of a relatively large structure, with the structure enclosing the electronic components of the display, power supplies and the like. A relatively large amount of floor space is taken up by the footprint of the kiosk structure and, in order to have kiosk presentations be more uniform, the structure is often implemented in the center of a public space. As well as establishing a large footprint, kiosk locations are often in the center of travel paths and interpose an inconvenient barrier to normal movement.

A further disadvantage of conventional systems is that they cannot be conveniently removed from a kiosk-type structure and deployed on a convenient wall or implemented as a flat, table-like structure. Various building codes do not allow separate pieces of structure to project from a wall, in a public space, more than approximately four inches. Given the present state of display technology, a display screen large enough to be viewable while affixed to a wall in a common space, would project out from the wall by more than 18 inches, thereby clearly establishing a code violation. One solution to this defect might be to countersink the display electronics into the wall, exposing only the surface of the screen. While reasonable in certain circumstances, this solution is not practical in the majority of cases, since most public space walls are load-bearing and cannot be windowed. Further, many public space walls establish a boundary between open or public space and an office space on the other side. Given a standard wall thickness, countersinking a display into the wall would project the backside electronics and wiring into the backside space, in a very obtrusive fashion. The opportunities for wall mounting can therefore be seen to be very limited, to say the least.

The requirement for an effective dynamic advertising system is therefore twofold. Such a system needs to be implemented in a manner that allows it to be conveniently affixed to a variety of surfaces, and in a variety of aspects, in public spaces. Such a system would necessarily reside on a public space wall in many instances and be so disposed so that it is viewable by a majority of passersby. The system must conform to building codes, particularly building codes relating to American Disabilities Act (“ADA”) safety requirements, and therefore should not project from the face of the wall by more than four inches. Additionally, the system should be able to be employed in a table-top configuration and positioned within a public space for easy accessibility.

In order to attract and retain viewer interest, the system should be configured to deliver focused content of a type with which a user would wish to interact. In the case of a commercial building, for example, such focused content might be a building directory or building information services, with dynamic advertising content co-displayed with the focused content, in piggyback fashion. Users would interact with the system in order to gain information about building services, tenant locations, and the like, and would be able to view directed dynamic advertising at the same time. The capture mechanism would therefore be rational and convenient to both users and building management, thereby removing one of the main sources of concern for property owners.

A system implemented in this fashion, and delivering this form of varied content, should also be able to be refreshed, from time-to-time, in order to maintain the relevance of the content. In particular, such a system would need to be implemented in a network configuration, such that content could be adaptively modified from a central location. This feature would eliminate the need to bring individual system displays down for routine content upgrade purposes, as well as establish a communication channel between and among the various display systems and a central control facility. This communication channel would allow interactive communication between a user at a particular display and a remote, live or real-time, information source, such as a building concierge or emergency services.

Coupling such a system together in a network would also allow the system to promote communication between a user and a third-party site over a larger wide-area-network, such as the Internet. This particular feature would allow the capabilities of such a system to be significantly expanded and take the focus of the delivered content from a small radius around the public space in which it is deployed to a significantly larger radius that encompasses an entire commercial area. This form of system focus would then allow for immediate interaction between a user and a dynamic advertiser in a manner that it is convenient, rational and directed. Network connected advertisers within the commercial area would be able to directly access and interact with potential customers, without those customers needing to seek out a particular facility. Visitors to a commercial office space, for example, might be able to make luncheon or dinner reservations with dynamic advertisers hosted on the system, obtain more detailed information on a tenant business by accessing that business's web site, or even make travel plans, arrange for car rentals, and the like.

Thus, such a system should represent a well-balanced public information site that also serves as an effective advertising platform. Economical broadband communication interfaces allow delivery of interactive content across a large network of displays, while proliferation of content available from wide-area-networks allows relevant localized information to be delivered to each site in an economical fashion.

### SUMMARY OF THE INVENTION

An interactive display system for use in a public space of a commercial environment comprises a thin, self-contained display unit, including housing which is characterized by length, width and depth dimension. The display unit further includes a video display screen, a single board computer including a large-capacity mass data storage unit and a touch panel dimensioned to fit over the video display screen. An interactive directory system, configured as a application software program, provides graphical directory information on the display screen. The directory system retrieves directory content from the large-capacity mass data storage unit and displays directory information upon request of the user by a user's accessing the system through the touch panel.

In one particular aspect of the invention, the directory is disposed within a building and includes an interactive building directory system, a building information system and a building concierge system, each accessible by a user's interacting with a respective display portion. The video display is configured to display information at a 16:9 aspect ratio, with a video display organized into a media window portion having a 12:9 aspect ratio and a control portion having a 4:9 aspect ratio. The directory listing, building information listing and building concierge listing are displayed in the media window portion.

In a further aspect of the invention, the interactive concierge system includes a video camera, mounted to have a field of view centered about a location at which a user would position themselves when using the display system. The concierge system further includes a microphone and a speaker system, the camera, microphone and speaker in combination, providing the display system with a bi-directional video phone connection capability. A network communication interface is configured to couple the concierge system to a wide area network. A concierge has a bi-directional video phone connection to the wide are network and, a user is able to establish a bi-directional communication with the concierge by interacting with a particularly defined touch-sensitive area of the control portion of the system.

In a further aspect of the invention, the directory information portion comprises a selectable occupant list, the list appearing in the media window portion when a user selects a directory information capability. In occupant specific informational content section appears in the media window portion when a user selects an occupant from the occupant list. A map of the commercial site, indicating the location of the selected occupant and directions thereto, are accessed by the user from the display. A control portion is located proximate to the system's media window portion and includes a plurality of user accessible touch-sensitive virtual buttons. The virtual buttons, correspond, respectively, to the interactive building directories section, building information section and building concierge section.

An additional aspect the buildings information section includes building amenities location information, building services link information, on site retail establishment listings and property management information. Property management information includes available space information, which further includes a link to a building map, the map graphically indicating a location, size, shape and amount of available space to a user in the media window portion of the display system.

### BRIEF DESCRIPTION OF THE DRAWINGS

These and other features, aspects and advantages to the present invention will be more fully understood when considered with respect to the following specification, appended claims and accompanying drawings, wherein:

FIG. 1, is a simplified, semi-schematic block diagram of the functional components of an interactive display system according to the invention;

FIG. 2, is a simplified, block diagram of a plasma display configured in accordance with practice of principles of the invention;

FIG. 3, is simplified plan view of a touch screen suitable for use in connection with the invention;

FIG. 4, is a semi-schematic illustration of a camera system, positioned for use in connection with a videographic capability for the display system of FIG. 1;

FIG. 5A, is a simplified plan view of an optical filter suitable for incorporation in the display system of FIG. 1;

FIG. 5B, is a simplified, partial cross-sectional illustration of an optical filter suitable for incorporation in the display system of FIG. 1;

FIG. 6A, is a simplified plan view of a display system installation, in accordance with the present invention;

FIG. 6B, is a simplified side view of a display system installation, in accordance with the present invention;

FIG. 7, is a simplified screen layout diagram of a default mode of a client interface, hosted on the display system of FIG. 1;

FIG. 8, is a simplified screen layout diagram of a building, campus or cluster directory mode of a client interface, hosted on the display system of FIG. 1;

FIG. 9, is a simplified screen layout diagram of a building, campus or cluster information mode of a client interface, hosted on the display system of FIG. 1;

FIG. 10, is a simplified screen layout diagram of a building, campus or cluster concierge of a client interface, hosted on the display system of FIG. 1; and

FIG. 11, is a simplified, semi-schematic block diagram of multiple local PC/display systems configured in a LAN/WAN architectural environment.

### DETAILED DESCRIPTION OF THE INVENTION

Initially, the present invention might be characterized as a large-screen electronic building directory system that also integrates advertising and non-commercial content and is positioned and deployed in various public spaces, such as commercial building lobbies, indoor shopping malls, airports or other commercial and transportation hubs. The digital directory delivers a high degree of varied informational and services related content, which is provided to a user along with suitably directed advertising media, in a form which is functional as well as visually pleasing, creating a new paradigm which is simultaneously valuable to property owners, advertisers, and users. Intended for use in public space environments, the system, which will be termed a client interface or interface herein, combines facility directory, facility information, concessionaires and advertising sponsor information in a user interface suitable for use in the target environment.

Ease of use, intuitive operation, audio and visual feedback, simplified content and uniform layout are integrated into the interface in order to make it usable by the broadest possible audience, including those users who are not familiar with computers, or facile in their use. Indeed, those with an appreciation of the art will immediately recognize that the novel system and method of delivering digital building directory services on a large-screen plasma display, rather than a conventional smaller-screen CRT or LCD display, substantially improves the acceptability of the interactive digital directory function by users and therefore opens up the market for broad use as opposed to the limited use that presently characterizes small-screen digital directory systems.

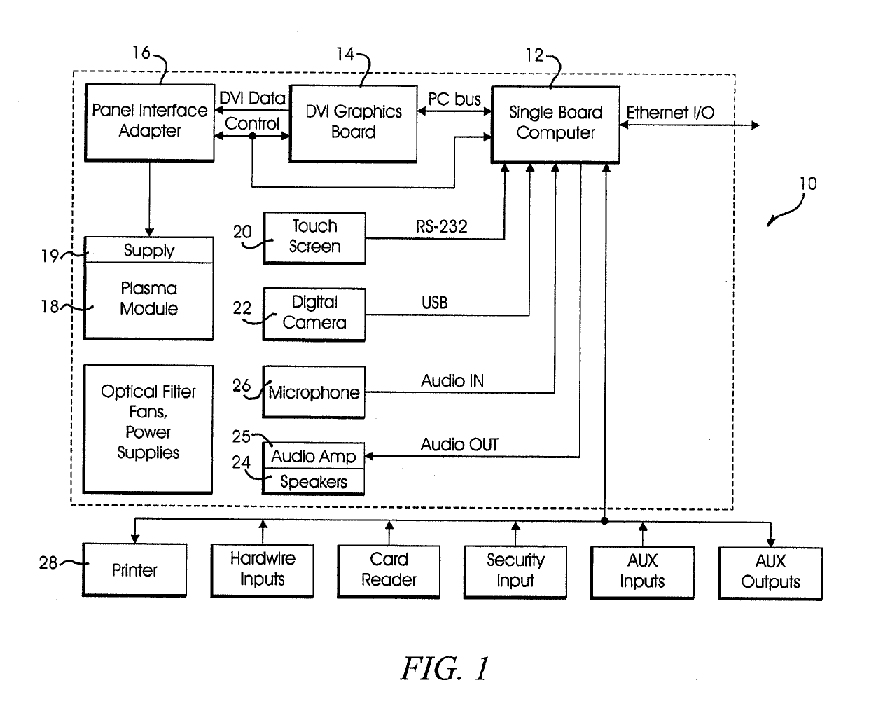

Prior to describing the unique features and functionality of the user interfaces' content delivery system, it will be useful to discuss the main functional blocks and hardware components of the system. Turning now to the semi-schematic simplified block diagram of FIG. 1, and interactive directory and information system, according to the invention, is generally indicated at 10. Fundamentally, the interactive directory and information system is an electronic content delivery network that uses large screen plasma displays deployed at various locations in public spaces to provide informational services and advertising content to a user. A local personal computer (PC) manages each displays content and interactivity. The display and PC combination is coupled to other, similar, systems in a network configuration and, as will be appreciated by those having skill in the art, from a network architectural perceptive, each display and PC combination represents a node on the network.

Each display and PC combination (what might also be termed a remote PC) is adapted to run a combination of locally provided and remotely provided content on the display and is effectively coupled to a wide area network (WAN), such as the Internet, in order to receive content update and other back-office communications from a central controlling authority, such as a network server system. Each remote PC is configured to operate in accordance with a standard, conventional operating system such as the Windows 98/NT operating system and include at least 20 GigaBytes local mass storage area. Processing power is provided by a high-speed, 32-byte CPU architecture, such as a Celeron or Pentium-class CPU manufactured and sold by Intel Corporation of San Jose, Calif. This degree of mass storage capacity and processing power is particularly advantageous to the interactive directory and information system where it is understood that each remote PC is designed to run a loop of discrete media clips which are able to be implemented in a variety of video or graphical-type files comprising several different file formats, as well as certain fully functional video-intensive “web sites” run directly from the local PC.

Each media clip is also provided with an associated interactivity vector or interactivity session, that is launched on the remote PC when selected, as will be described in greater detail below. Additionally, remote PCs are configured to deliver other forms of interactive content, such as building, transmit terminal or shopping mall directory services, simultaneously with the aforementioned media clips. Given the layout and architecture of a building, campus, shopping mall or transportation hub, remote PCs are coupled in either a single-node or multiple high-node configurations within a particular installation.

Accordingly, each remote PC is able to either communicate directly with the central controlling authority over a WAN, or in the case of a multi-node configuration, coupled together into a local area network (LAN) which is then coupled to the WAN by means of a local LAN server. In the case of a single-node connections, a remote PC might be coupled to the WAN (the Internet, for example) by means of a telephone subscriber line through a modulator/demodulator (modem) implementing DSL class service. Alternatively, a remote PC could communicate with the WAN over a cable (a coaxial or fiber cable implementation) through a high-speed cable modem. The particular WAN interface technology chosen for any given remote PC is not particularly germane to the present invention, except that the WAN interface should implement a generally high-speed data transfer rate and operate at frequencies in the range of 1 MHz, or above. For multiple-node configurations, remote PCs will preferably be coupled together in accordance with at least a 10/100 BASE-T Ethernet LAN configuration, with the local LAN server coupled to the WAN at whatever speed is necessary to support LAN-to-WAN traffic.

Returning now to the exemplary embodiment of FIG. 1, the interactive directory and information system 10 includes a single board computer 12 in turn comprising a large-capacity data storage area, such as a large-capacity hard disk drive, as well as high-speed CPU, as was described above. The single board computer 12 is implemented, simply, as any industry-standard processor board capable of running the required operating system, client application and outputting the required media types. As will be appreciated by those having skill in the art, there are a number of such processor boards available from a large number of suppliers, with various form factors, performance, metrics and capabilities from which to choose. Depending on the mechanical dimensions and floor plan placement of other components of the system, certain of these available processor boards may be more appropriate than others. The particular choice of a particular processor board for use as the single board computer 12 is a matter of design selection and is left to the option of the system designer of any remote PC. Since the interactive directory and information system 10 is contemplated as coupling to a LAN, in some configurations, the single board computer 12 includes an integrated Ethernet I/O as well as conventional RS-232 and universal serial bus (USB) I/O capabilities.

Local mass storage, although typically provided separately from the processor board, is coupled to the processor board and is a considered a part of the single board computer 12. Any industry-standard 3.5 inch class hard disk drive (HDD) is acceptable, provided it supports the peripheral device bus interface established by the single board computer. Generally speaking, the highest-density hard disk drive, in this class, would be advantageous. Hard disk drives in this particular category are available from various manufacturers, such as Western Digital Corporation, Seagate Technology, Hitachi, Maxtor, and others.

The single board computer 12 is coupled to a Digital Video Interface (DVI) graphics board 14 by means of a peripheral interface bus, such as a PCI bus, SCSI bus, AGP bus, or the like, or incorporates an embedded digital output functionality. The DVI graphics board 14 is a conventional industry standard graphics card that supports the Digital Video Interface Standard. A particular example of a DVI graphics board that is suitable for incorporation into the interactive directory and information system of the invention, is the ATI Technologies Rage Fury Pro, manufactured and sold by ATI Technologies, Inc. This particular DVI graphics board provides 32-byte true color 3D acceleration, full OpenGL ICD, Direct3D and DirectX acceleration and further incorporates an up to 32 MB frame buffer in order to process 3D textures.

Suitably, and in accordance with the invention, the DVI graphics board 14 includes not only the conventional video-in/video-out connectors, but also a DVI connector for coupling the graphics board 14 to a digital flat panel-type display. In this regard, DVI data is provided to a panel interface adapter 16 which functions to process the DVI data into a form usable by a flat screen, plasma-type display, as will be described in greater detail below. Depending on which plasma display contemplated for use, and its panel interface specifications, several commercially available interface solutions are suitable for incorporation into the system of the present invention, or a custom interface board may be developed and used. In particular, several current generation plasma displays, for example, support a parallel digital data interface that is compatible with the AV-DVI-RCVR flat panel video sub-system receiver, manufactured and sold by AVED Display Technologies, of Tustin, Calif. This particular panel interface adapter board 16 is DVI 1.0 compliant and incorporates a single channel link TMDS interface which supports resolutions up to UXGA and HDTV. The panel interface adapter board 16 further provides for power regulation, filtering and distribution for flat panel, and additional functionality such as a touch-screen. An on-board controller allows for additional functionality such as digital PWM dimming, illegal mode detection, application specific I2C and I/O control functionality.

In accordance with practice of principles of the invention, the video display, coupled to the panel interface board 16 is suitably configured as a color, plasma display module 18 which is selected not only because of its display aspect ratio, but also because of its uniquely thin design. As will be described in greater detail below, the particular thickness of the plasma module 18, along with its associated power supply 19, allows the interactive directory and information system 10 of the invention to be implemented in particular locations in a building that were heretofore inaccessible to visual display devices because of their inappropriate shape. The plasma module 18 is a 42-inch diagonal color plasma display module, with a resolution of 853(H)×480(V) pixels, utilizing AC plasma technology and including an 8-byte digital video signal interface for each RGB color.

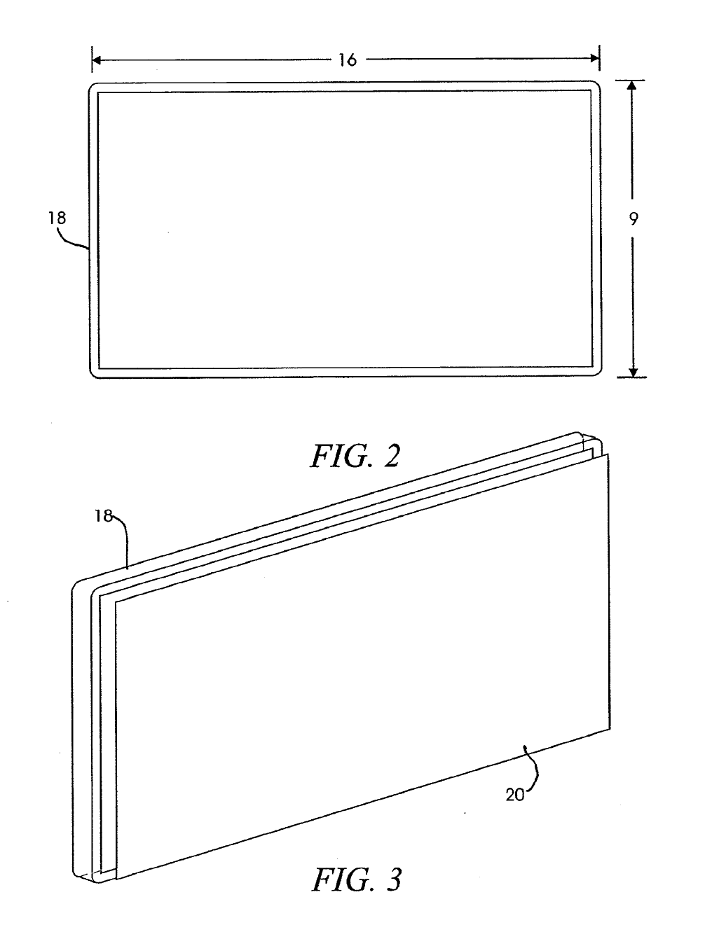

To digress momentarily, in a plasma display panel, row and column electrodes are placed between glass substrates. A rare gas is then introduced into the space between each substrate. When a high voltage is applied to the row and column electrodes, the gas is activated, resulting in production of ultraviolet light, similar to the operation of a fluorescent lamp. Ultraviolet light then activates a phosphor that has been coated on the inside surfaces of the glass substrates, and visible light is emitted from the panel. This digression is important since plasma display modules offer vibrant color reproduction in an extremely thin and low-profile package. In particular, a suitable plasma display module, such as the NP4203MF02, manufactured and sold by NEC Corporation, has an outlined dimension of 987(W)×854(H)×48(D) millimeters which in turn defines a display area of 921(H)×518(V) millimeters. Given this display area, it will be appreciated that the display aspect ratio is 16:9, which conforms to the HDTV, wide screen standard, as depicted in FIG. 2.

It is particularly noteworthy that the plasma module 18 incorporates an internal power supply 19 which is disposed within the plasma modules' form factor without adding any significant depth dimension to the composite system. Due to the inherently noisy environments, particularly with regard to EMI and IR, generated by plasma technology, and the plasma modules' high power requirements, power supplies tend to be very specialized components and are commonly provided separately from the display. Current-generation plasma display modules are approximately 40.0 millimeters thick, with the entire back-plane filled with electronics.

Conventional power supplies are typically 43 millimeters thick and were required to be mounted directly behind the plasma module, as opposed as to being embedded within the module as in the present invention. As a result, the combined thicknesses of a conventional plasma module and power supply would be approximately 83 millimeters, or 3.26 inches. When combined with the width of a touch screen, optical filter, chassis and mounting fixture, the resulted mounted chassis thickness exceeds 4.0 inches, even without the remaining components of the interactive directory and information system of being taken into consideration. As will be described in greater detail below, exceeding a 4.0 inch thickness is particularly disadvantageous for a display system intended to populate a commercial building.

However, and in accordance with the invention, the power supply 19, although exhibiting a 43 millimeter footprint, is disposed completely within the plasma module and forms an integral part thereof. Thus, when the module and power supply combination is disposed within a chassis, which adds approximately 4 millimeters to the thickness of the combination, the plasma display will be understood to have a thickness of approximately 52 millimeters.

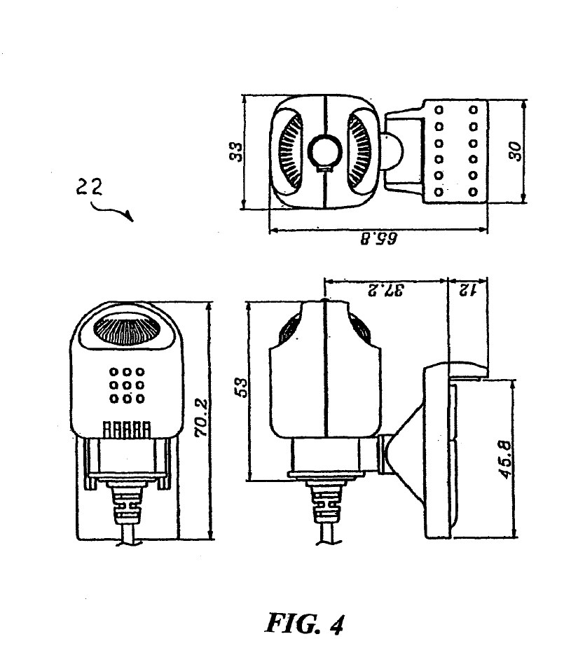

A touch panel or touch screen 20 is dimensioned so as to fit over the approximately 20 inch×36 inch display area of the plasma module 18, as indicated in FIG. 3. There are several touch screen technologies currently available for desktop monitor-type applications, including infrared, analog resistive, capacitive and surface acoustic wave. Although any of these would be suitable for use with the plasma module 18, an infrared touch screen has been incorporated into the system of the invention as the most suitable technical choice. Infrared touch screens do not interfere with or cloud the image provided by the plasma module 18 and are typically packaged in a bezel that, when coupled to the plasma module, only add approximately 13 millimeters but to the overall thickness (or depth) of the display system. The touch screen 20 is coupled to the single board computer 12 through an RS-232 port and can be controlled by a very wide variety of software drivers, including several Unix workstation drivers, Unix microcomputer drivers and PC drivers, compatible with Windows NT, Windows 95/98 and IBM OS/2. It should be noted at this juncture, that certain touch screens might be coupled to the single board computer over the RS-232 port, while others might be configured to avail themselves of the USB port typically provided by most single board computer systems.

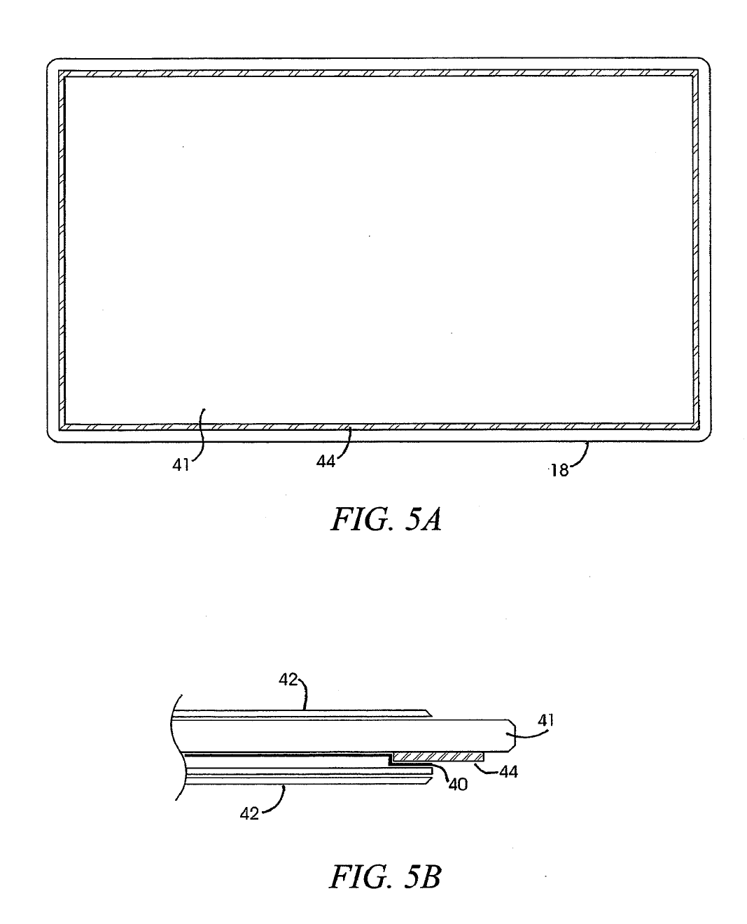

A digital camera 22, depicted in FIG. 4, is coupled to the single board computer 12 via the USB port, or alternatively the RS-232 port. On the digital camera 22 suitably implemented as a low-profile CCD camera which delivers video data to the single board computer in accordance with the USB digital video standard, or alternatively an NTSC camera converted to USB using any one of several commercially available conversion products on the market. A suitable CCD, USB camera is the YH9VC1 USB camera, manufactured and sold by Sharp Corporation. The USB camera conforms to the Universal Serial Bus Specification Revision 1.1 and Serial Interface Engine of the USB Developers Conference and is able to produce an image size of 640×480 pixels at a frame rate of about 30 fps. It should be understood, however, that maximum frame rate obtainable by the system depends upon CPU speed, displayed image size, selected compression ratio and the availability of USB isochronous bandwidth. In one particular configuration, the digital camera 22 has a case size of approximately 33 millimeters wide by 33 millimeters high and with a 53 millimeter depth. It should be noted that the cameras' approximately 53 millimeters depth allows the digital camera 22 to be mounted in conjunction with the plasma module 18, without exceeding the 4.0 inch maximum depth target. In this regard, the digital camera 22 might be mounted on the plasma modules' case or chassis, either on the top or bottom edge, or alternatively, it might be mounted within the plasma modules' case or chassis with a lens aperture provided in the case. All that is required that there exist a 33×33×53 millimeter open footprint within the plasma module case in a location unobstructed either by the plasma display or the touch screen bezel.

Audio capability for the interactive directory and information system 10 is provided by high-fidelity loud speakers 24 coupled through an audio amplifier 25 to the “audio out” plugs of the single board computer 12. In this regard, the single board computer 12 might be provided with a simple audio I/O card or a multimedia card having audio I/O capabilities. With regard to “audio in”, a microphone 26 is provided such that a user of the directory and information system is able to voice interact with the system. When considered in combination with the digital camera 22, the microphone and loud speaker combination gives a system user the ability to interact with the system over the full multi-media range. As will be appreciated further in the specification, the camera and audio capabilities allow full-duplex, two-way audiovisual communication between system users or between users of the system and a remote site, such as a building concessionaire, restaurant host, building rental office receptionist, or the like. Although the microphone component 26 has been described as a separate component or element of the system, it should be understood that various small form factor digital cameras come complete with an integrated microphone, thus eliminating the need to provide this component as a separate element.

In particular configurations where the digital camera 22 is mounted on the exterior top or bottom surface of the plasma module 18, the digital camera might be motorized and computer controlled, such that through conventional image recognition or voice recognition techniques, the camera could be directed to focus its objective lens at a user who is standing in front of the display screen, for example, or focus its objective lens at a user that has invoked a video or teleconferencing application and who is engaged with the system. These voice and image recognition techniques are well understood by those having skill in the art and can be easily implemented by in connection with a suitable digital camera, by merely providing the appropriate driver software as an application in the single board computer 12.

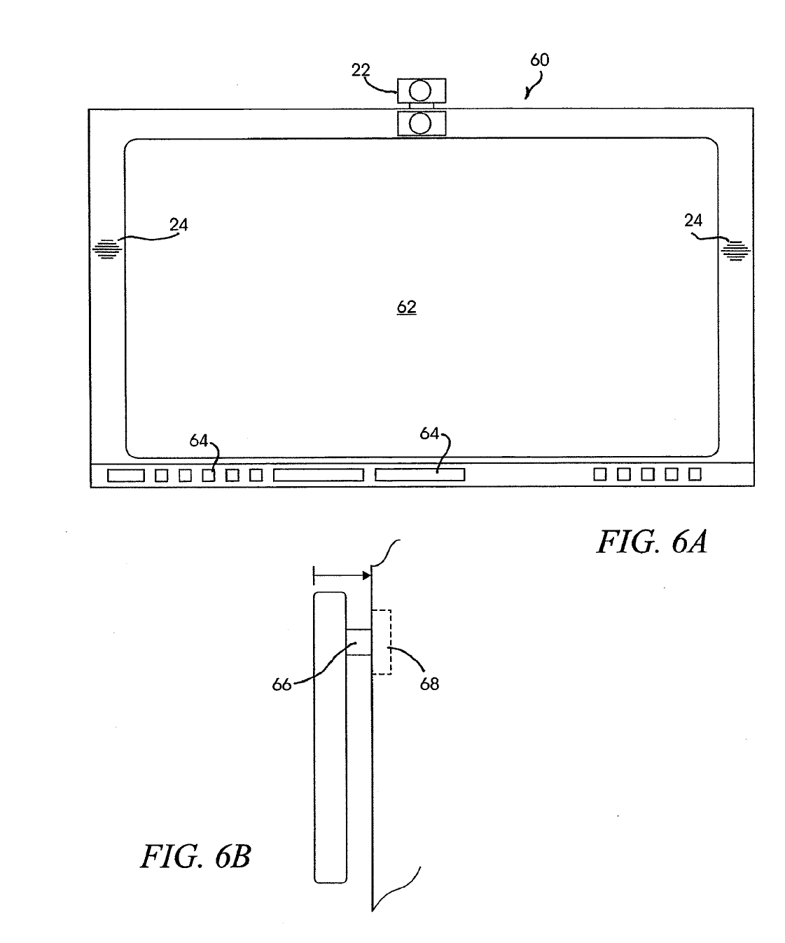

Due to the electrically noisy environment generated by the plasma module 18, care must be taken to provide proper optical filtering in order to dampen the level of EMI and IR emissions from the plasma modules' chassis. As depicted in FIGS. 5A and 5B, optical filtering is typically accomplished by disposing a transparent, conductive thin film material layer 40 over the surface of a reinforced glass plate 41, and mounting the plate 41 over the glass panel side of the plasma display 18. A 220 micron antireflection coating 42 is disposed on the back side of the reinforced glass plate, in proximity to the plasma display and also on the front surface of the optical filter. The edges of the conductive thin film material layer are laminated over a 15 to 25 micron thick ground contact electrode 44 which is formed about the outside edge of the glass plate. Suitably, and in conformance to practice of principles of the invention, the entire optical filter adds no more than 3.6+−0.3 millimeters to the overall thickness dimension of the plasma display module.

Since the directory and information system according to the invention is a PC based system, various other input and/or output devices can be included within the system and coupled thereto in conventional fashion. For example, printer 28 can be coupled to the systems' printer port if it is desirable to make printed material available at the system site. Likewise, a credit card reader 30 allows credit card entry facilities to the system site to promote direct commerce activities, or to function as a personal ID reader or for any other purpose which might involve information or data stored on a credit card-type magnetic memory strip. If the directory and information system according to the invention were to be used in the context of a video conferencing system, the system would naturally be equipped with other standard input devices such as a mouse and keyboard. The mouse and keyboard might be wireless or might be connected to the system using standard USB connectors.

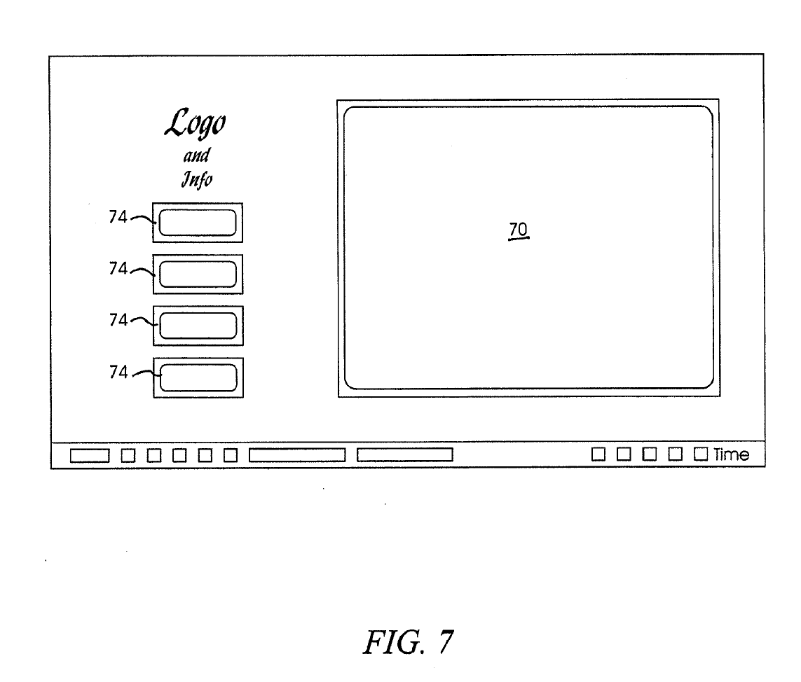

Turning now to FIG. 6, an exemplary embodiment of an interactive directory and information system, as it would be implemented in a form suitable for mounting in a prominent location on the wall of a building, is depicted in plan and profile views and indicated, generally, at 60. With reference to the exemplary embodiments of FIG. 6, the system complements are integrated into a single (or two-part) chassis and mounting bracket combination that, when mounted onto a building wall, protrudes no more than 4.0 inches from the wall surface. Accordingly, it will be understood that the thickness or depth dimension of the system 60 can be no more than 4.0 inches, and should preferably be somewhat less in order to allow for building wall irregularities. The 4.0 inch thickness requirement is imposed such that the system 60 is able to meet ADA code requirements for wall-mounted systems in the common areas of commercial buildings. Further, and in order to meet the aesthetic requirements of most property owners, the height and width dimensions must also be kept to a minimum, thereby eliminating the possibility of a thin but very tall (or very wide) enclosure. A suitable configuration that yields a critical mass of acceptability is one that only exceeds the visible display area (measured diagonally) by an average of about 8% to about 9% per side, i.e., approximately 3 to 4 inches per side for a 42 inch class display.

It should also be understood that the system is capable of being implemented in a freestanding configuration, in which case the system is deployed in a thin-profile vertical or a slightly angled position, whichever is most appropriate for efficient viewing. If it is desired to angle the viewing surface of the display, the display surface is lowered to approximately waist level, and positioned at an angle of approximately 45 to approximately 90 degrees with respect to vertical. If the display is mounted at a 90 degree angle, it will be recognized that it would have the same aspect as a tabletop and would be just as accessible to a user. In a freestanding configuration, the thin form factor of the system chassis dramatically improves the acceptance rate in commercial spaces when compared to the traditional “kiosk” enclosures that are large, solid objects which take up a considerable amount of valuable common space.

In either aspect, either freestanding or wall mounted, it is contemplated that the system 60 will have a volumetric footprint (a form factor) of no more than 43 inches in width, 31 inches in height, and 4 inches in depth. Within this form factor, the system 60 hosts a centrally located plasma display screen 62 which has viewing dimensions of approximately 36 inches in width by approximately 20 inches in height for an approximately 16:9 aspect ratio. A set of hard-wired inputs, provided in the exemplary embodiment of FIG. 6 as buttons 64, may optionally be located on the system bezel and provide a user input path in addition to the system's touch screen. Hard-wired input capabilities are particularly advantageous for use by the visually impaired and, thus, might suitably include buttons coded with Braille indicators informing the user that the system was a building directory, for example, which supports blind users. Another option is to place Braille directions on the bezel next to a virtual button on the screen, which would instruct the blind user to touch the virtual button to receive help. By touching or depressing one of the buttons 64, the system establishes a videophone connection between the site and a “courtesy assistance” person or concierge, who interactively verbally (and visually) assists the user in connection with directions within the building or in the local community. Similarly, one of the hardware input buttons 64 can be configured as an emergency response button which enables a video telephone connection with emergency services, such as fire, police or other emergency response agencies.

In the exemplary embodiment of FIG. 6, loud speakers 24 are disposed behind acoustically transparent grilles or louvres disposed in the system's chassis to either side of the display screen 62. A digital camera 22 might either be mounted in a central location along the top edge of the system bezel or might be mounted in an interior position along that portion of the system bezel which is above or below the display screen 62.

Power and data connection is made between the system 60 and a building's power and data distribution system through. The system 60 power input and the PC Ethernet I/O connections. The integral mounting bracket is designed for minimal added protrusion while meeting Building Code structural integrity and earthquake safety requirements, while providing for power and data connections facilities for the system 60. The mounting bracket is mounted onto the wall after power and data cables are run and terminated using standard construction techniques. As the system 60 is moved into position, the power and data couplers 66 are mated to the corresponding wall connections and the system 60 is secured to the bracket with lock-down screws.

In operation, directory services, public information and general multimedia content is delivered to a user by the system 60 in accordance with an application software program, hosted on a local PC-type computer which operates and controls information and content displayed on the display screen 62. The application software program is multimedia capable and defines a presentation layer, termed a client interface herein, through which a user interacts with the system. In addition to a presentation layer, the application software program includes an application layer which comprises a number of embedded software objects for accomplishing particular functions, such as internet access, maintenance functions, remote site management, reporting, diagnostic services, and the like. With regard to the client interface, the program allows a user to avail themselves of the capabilities of the system in an efficient, rational form by having the user make various presentation selections merely by touching an indicated portion of the display screen.

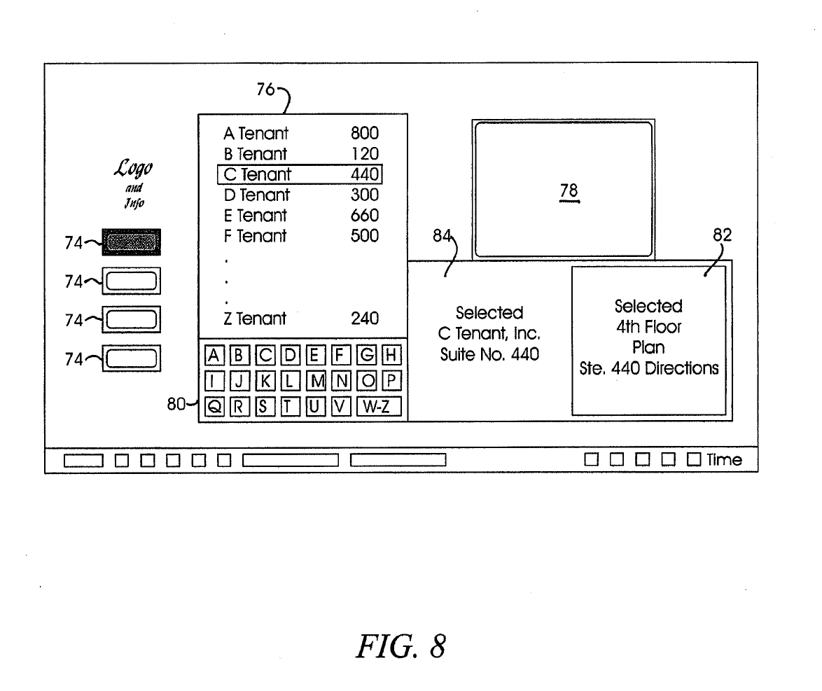

Turning on to FIG. 7, there is shown in simplified, semi-schematic form, an exemplary client interface screen as it would normally appear on the system's display. The client interface is designed to run on 16:9 aspect ratio displays, using non-traditional input methodologies such as a touch screen or voice recognition, for example. Intended for use in public space environments, the client interface combines various other information in addition to providing basic building directory functionality, such as on-site property information, community content, video-concierge functionality, and interactive advertising content, all in an interface suitable for use within the target environment. In this regard, the particular client interface shown in FIG. 7, and in additional figures to be described in detail below, is an interface developed for use in connection with a multi-tenant commercial building environment. This description is for exemplary purposes only and is not intended to limit the novel system to commercial building applications. Indeed, those with an appreciation of the art will immediately recognize that the novel system and method can be used in connection with various other structures having a defined public space, such as transportation terminals, campus environments and the like.

In the exemplary embodiment of FIG. 7, the client interface is depicted in a default mode which reflects the state of the interface when no user has interacted with the site for a certain period of time. Specifically, the client interface may be considered as having two principal components, a “media window” component 70 and an interface control component, generally indicated at 72. The media window component 70 comprises approximately 88% of the screen area and as such provides for the greatest potential media value while still allowing for additional functions to be indicated in the interface control component area. The interface control component 72 is positioned proximate to the media window 70 and suitably includes a set of “virtual buttons” 74 which control access into the various regions of the interface: the building directory, building information, community content, and concierge services, for example.

Thus, it will be understood that the majority of the screen is dedicated to the “media window” 70 with the remaining screen portion including “virtual buttons” 74 that hint of additional informational content that is available from the site. The specific layout of the client interface is particularly advantageous, since the media window portion 70 allows for use of industry standard 4×3 aspect ratio content with minimal scaling or small vertical “dead-bands” (solid colored vertical bands used to fill the additional unused area of the media window), as well as standard 720×480 resolution high-resolution video standards. Were the interface to be hosted on a standard 4×3 aspect ratio display, the width of the media window would necessarily have to decrease in order to provide sufficient space next to the media window for the virtual buttons. Any decrease in the width of the media window would require additional decreases in its height, in order to maintain the standard 4×3 aspect ratio. The net result, in accordance with the invention, is that the media window size may be optimally designed for a 16×9 aspect ratio display, in particularly the 848×480 pixel resolution versions, since the media window can directly support standard VGA resolution, i.e., 640×480 pixels, and standard video resolution, i.e., 720×480 pixels, for that class of display. In the case of higher-resolution plasma displays such as 1365×768, the same design strategy supports the industry-standard 4×3 aspect ratio XGA standard of 1280×768 pixels.

It should further be noted that in its default mode, the media window portion 70 of the client interface continually runs, on an open loop basis, a set of media files that have been queued or scheduled for play by a scheduling routine that forms a pertinent part of the software application program. The particular form of the queuing routine, or scheduler, is not particularly important to this aspect of the invention. Indeed, scheduling routines are well known to those having skill in the art, and represent nothing more than a list, i.e., a “play” list, of various media files that might be stored either in mass storage memory comprising part of the embedded local PC of the system or, which might be stored in mass storage memory of a building server and transferred to the local embedded PC over a building or facility LAN. Media files might even be stored in a centralized location, such as an enterprise server which, in turn, might service a number of building servers or facility LANs.

Multimedia files are accessed, extracted and played in the media window portion 70 of the client interface in accordance with a schedule developed and set up through the scheduler. These multimedia files could include any form of graphical, animated graphics, or videographic information, but preferably include full-motion video in the form of pre-produced advertising. The files might be .mpg, .avi, .rm, or any other format that supports full-motion videographic reproduction, complete with an audio component. These various media files are constantly presented in the entire media window 70, when the system is in default mode.

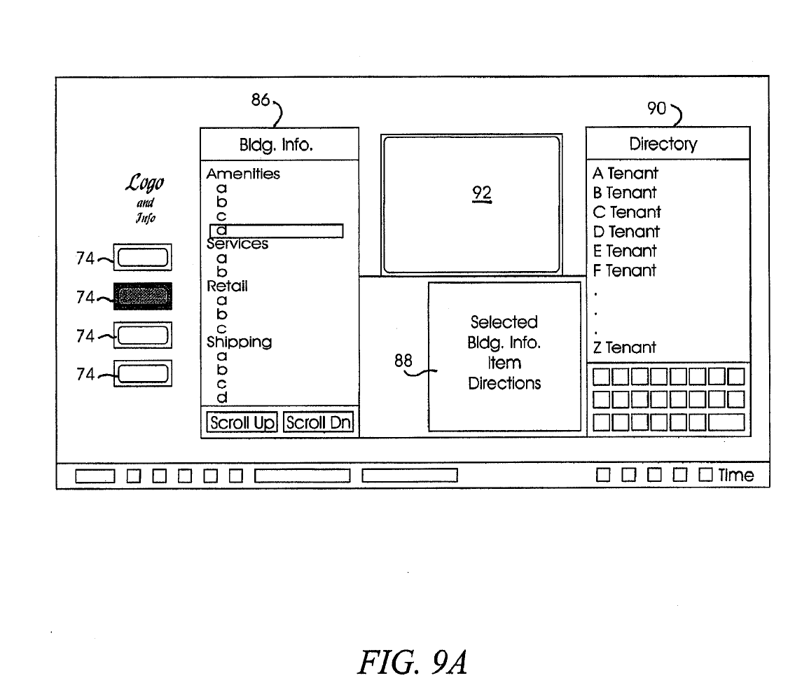

If a user wishes to engage with the system, in order to access the building's directory listing, for example, a user need only approach the system and depress the “virtual button” 74 labeled “directory.” As shown in the exemplary screen shot of FIG. 8, depressing the directory “virtual button” causes the system to modify the content of the media window 70 such that it includes a “building directory content” portion 76, along with a reduced media window 78 that continues to play various multimedia files in accordance with scheduled programming. Depending on the selections made or other relevant psychographics information about the user made available to the system, the normal scheduled programming can be modified such that specific targeted content can be delivered to the user in the media window. As will be appreciated by those having skill in the art, this targeted content delivery capability, when used in conjunction with advertising content, can significantly increase the value of advertising and, as a result, the practical market value of the invention. Furthermore, the integration of targeted advertising capabilities into a building directory system represents a market innovation of significant importance.

The building content portion 76, that might also be termed the directory section, displays a list of building tenants, in the particular case of a commercial office environment for example, that can be either selected in order to obtain additional information about that particular tenant, or scrolled through in order to expose all of the tenants provided in the building tenant list.

Specifically, the directory listing 76 includes an alphabetical list of building tenants, along with their corresponding building suite assignments. Beneath the list, a pair of “scroll-up” and “scroll-down” virtual buttons are provided beneath the tenant list. These virtual scroll buttons are accessible to a user through the touch screen and controls display of tenant information on the list. A set of “alpha” character virtual buttons 82 are also provided in addition to the virtual scroll buttons and offer a user an additional methodology by which site or building tenants might be identified. Selecting the first letter of the tenant name automatically scrolls the list forward to that point, allowing for faster navigation with long lists.

Additional information is available with regard to any particular building tenant, by having a user touch that portion of the screen on which the tenant's name is displayed in the directory listing. When any tenant name is selected, the screen is reconfigured to present additional information relating to that tenant in a tenant information field 80. The tenant information field 80 suitably includes a map 82 of the building floor on which that tenant's office suite or suites is located. The building floor map 82, which might also be termed a tenant location plan, defines the floor plan of the building on that particular floor and indicates which portions of the floor plan belong to the tenant. Lobbies or entrance doorways are identified, along with a route diagram leading from the elevator core to the tenant's main entrance.

Additional textual or graphical information about the tenant may be provided in the media window above if desired. The commentary field 84 could include the type of business the tenant is engaged in, where and how the tenant wishes to receive mail and other deliveries, business hours, or the like, and could also be interactive and include multiple content formats including videographic-type content.

Depressing the second virtual button, the “building information” button, further modifies the screen to include a building information display space 86. The building information display space 86 suitably comprises a list of building amenities and services, which when accessed by a user by touching the related service or amenity on the touch screen, gives a location for that building service or amenity on a graphical floor plan of the building 88. Various building amenities are included in the building information list, such as the location of fire extinguishers or fire alarms, restrooms, service entrances, freight elevators, telephones, vending machines and the like.

Locations for various building services are also included in the building information area 86 and would necessarily include the locations of the building leasing offices, maintenance offices and/or maintenance storage areas, building management and security offices, and the like. If the building contains any retail services or shops, these can also be listed in the building information space with information displayed about each retail service and its location, when that service is accessed by a user. In a manner similar to the building directory, the building information area 86 also includes scroll buttons such that a user is able to traverse the list if there are too many entries for efficient display all at once. In addition to its novel functionality of being able to provide building information to visitors of commercial office properties, the building information field 86 also includes the ability to show a user all of the rental space available, either within that particular building or within that building and neighboring buildings, in the case of a campus or an office building cluster. Accessing the “available space” category by touching the appropriate listing on the building information area 86 causes the system to display a set of building floor plans, with each floor plan indicating the space available for rental. Users are able to page through the various floor plans, in the floor plan display space 88 by either “scrolling” through the various building floor plans or by traversing the building floor plans by pressing “virtual buttons” indicating a floor with available space.

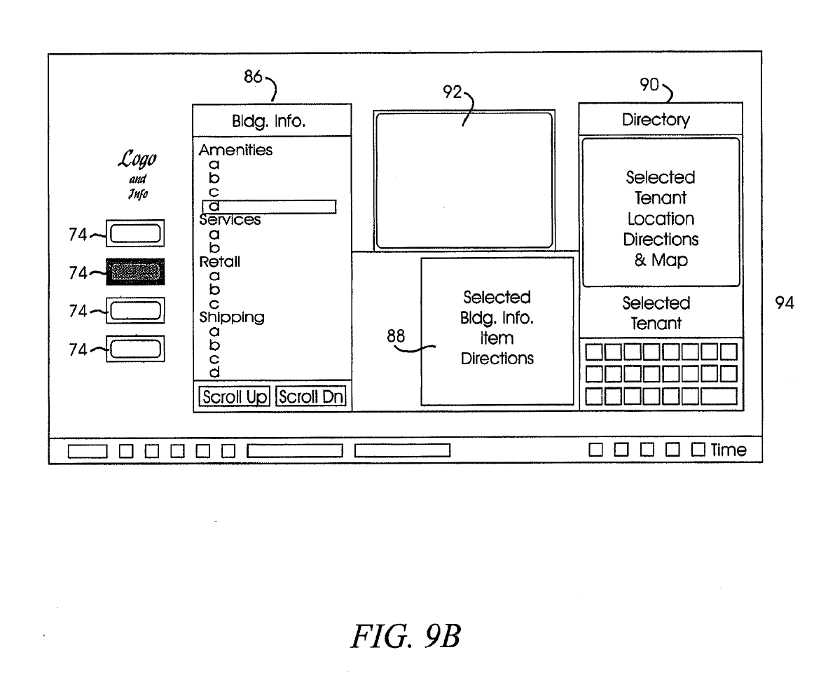

This specific feature is particularly advantageous because it provides the property management or leasing authority with an additional, real-time mechanism by which to identify and capture potential sales leads. In addition, including videophone access to live leasing agents can dramatically increase the sales success rate, which translates to added value for the property owner. It should also be appreciated that in the exemplary embodiment of FIG. 9, the building directory list, illustrated in the exemplary embodiment of FIG. 8, can also be provided as part of the display when the building information virtual button is accessed by the user. The building directory 90 is incorporated as an always-visible, always-usable display section, even when the building information functionality has been accessed by the user. It should be appreciated that the system is essentially a two-user interface which allows a first user to view building amenity and services information, while a second user can access the building directory or tenant listing. This feature is quite advantageous in that property owners of commercial office space often require that a building directory always be available to a visitor so that visitors do not have to wait their turn until they can determine the suite number of their tenant. Without the multi-function capability of the client interface of the present invention, one would be required to deploy multiple screens into the same public space, but with one screen being reserved for the building information, while other screens would become available for building services, and the like. This would significantly increase the cost of such a system and, more importantly, it would decouple the directory from the system's advertising functions and, in so doing, destroy the integrity of the advertising “quid pro quo” in which users will accept advertising if given something of value in return.

In connection with advertising, the exemplary screen shot of FIG. 9 also includes a reduced-size media window 92 which continues to display multimedia advertising, in accordance with a play list controlled by the scheduler. It should be noted that the small media window 92 of the exemplary embodiment of FIG. 9 is not positioned in quite the same location as the reduced-size multimedia window 78 of the exemplary embodiment of FIG. 8. Indeed, the size and/or specific location of any or all of the various display areas relating to the system may be adjusted or modified to suit any property owner's sense of visual proportion and presentation. The building information and directory listings could be swapped, and the building floor plan graphical data might be mapped into an area at the top of the screen, with multimedia advertising running in a reduced-size media window at the bottom center portion of the screen. All that it is required for practice of principles of the invention, is that the display area be divided into sectional components, with various forms of information being presented within each sectional component, and particularly that one of the sectional components be reserved for multimedia advertising display. Additionally, the display components should be allocated between the building information and building directory listings, such that two separate users are able to access building amenity and services information and building directory or tenant listing information simultaneously through the same client interface.

Need to review screen shots/figures, and compare against latest versions.

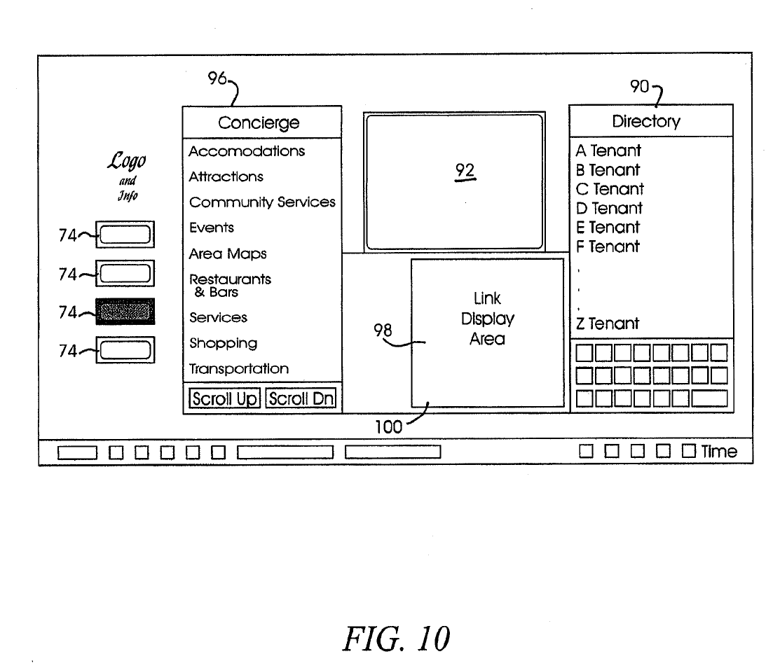

In this regard, and in the exemplary embodiment of FIG. 10, building directory information is presented in the building directory space 90 in a manner somewhat different from the exemplary embodiment discussed in connection with FIG. 8, above. In situations when both the building directory and building information functions are being simultaneously accessed, the building directory function is unable to display both a building floor plan (82 of FIG. 8) and a tenant commentary field (84 of FIG. 8) in the space allocated to those functions in FIG. 8. Indeed, that portion of the display is allocated to building floor plan graphics 88 that pertains to the various building information categories contained in the building information listing 86.

When a particular tenant is selected from the tenant list, an additional “pop-up” window is presented to the user with the relevant information. This is essential in order to maintain a secondary directory with minimal width without compromising the readability and usability of the directory function.

Turning now to the exemplary embodiment illustrated in the screen shot of FIG. 10, the community “virtual button” causes the system to display a listing of local community information, including restaurants, transportation services, maps of the area, community services, and the like. As was the case with the building information section, above, the concierge display section 96 occupies a portion of the display similar to that occupied by the building information section (86 of FIG. 9). Selecting an item from the community section displays details about the various companies or services listed, by category, on the community section listing. Details regarding the selected company or service are provided in the media window or in a “pop-up” window. The detail display area 98 is able to provide textual, graphical, or videographic information relating to a supported company or service and additionally displays a street or location map 100 which is able to give location information, as well as directions, relating to that particular company or service.

The detail display section 98 is also able to support multimedia video telephone communication with certain supported companies or services selected from the community listing 96. These particular community listings are linked, through the local embedded PC and IP-based communications network, to a particular company's personnel equipped with the appropriate videophone-capable equipment (which could be as simple as a PC, digital camera, and broadband Internet connection). This system establishes these videophone connections with supported companies or service, through the system's embedded camera and audio speakers. For example, a user is able to make restaurant reservations by selecting the “restaurants” listing from the community list 96. A listing of restaurant categories is presented to the user which can then be selected to identify restaurants of interest in the local area. The specific restaurant can then be selected, and if the selected restaurant supports two-way communication with this system, the media window display space 98 is replaced with a videographic image of the reservation desk of that particular restaurant. In this manner, restaurant reservations may be made or menus may be viewed in real-time, without the need for a user to locate and access an additional communication channel to the restaurant.

In a similar fashion, golf tee times can be made or movie tickets can be purchased by accessing the community functionality of the system. Additionally, and in accordance with practice of principles of the invention, the system is able to establish a videophone connection to a live concierge, allowing for a true virtual concierge function to be delivered. It will be appreciated that the live concierge need not be located physically within the building. Indeed, the concierge could be located in an off-site facility, and accessed through the system by using the system's LAN and/or WAN communication channels. It will be appreciated that the impact of this particular feature of the invention is substantial, allowing true concierge functionality to be distributed throughout a large commercial property, without requiring a large and generally cost-prohibitive number of personnel. It will also be appreciated that the system is able to provide concierge services to certain classes and scales of properties that could not otherwise justify the expense of perhaps even one live person.

One of the aspects of the invention that should further be considered, is that each of the various functional displays, exemplified by the building directory, building information and community screens, is that each of these screens includes a reduced size media window 92 that continues to play pre-programmed advertising information while the various functional portions of the various screens are deployed. This pre-programmed advertising information can be in multimedia form that includes full-motion video, as well as audio components. Necessarily, when the videophone portion of the system is being used, an audio cut-out, either a mechanical or a software switch, substitutes the videophone audio for the audio component of the pre-programmed advertising multimedia content. In this particular regard, the advertising information might be provided by the various companies or services listed on the community display or might even be subscribed by major market advertisers that have no particular relationship with the building, campus or cluster which is hosting the system of the invention. Regardless of their source, supported advertisers may be accessed by selecting the media window of the system which, in turn, deploys a screen giving a listing of the various advertising sponsors, as well as further detailed information about products and services offered by those advertisers when a particular advertiser is selected from the list in a manner that was described above, in connection with the community or building directory listings.

Advertisers are able to directly interact with users through the videophone connection described above. While the media window provides the user with the ability to scroll through a list of sponsors, view their ads, and find out any additional information if the advertiser has provided, the system is also able to provide an electronic link to an advertiser's web site or communicate with an advertiser's customer service or sales group through the system's videophone connection capabilities. The impact of this particular functional capability is quite significant when it is considered that two-way videophone communication with an advertiser creates, in effect, a national network of thousands of virtual outlets within other physical spaces. A particular building, campus or cluster's common spaces could, therefore, accommodate virtual travel agencies, airline reservation counters, or any other virtual customer order center for products and/or services that might be requested by a user who is merely passing through a public space.

Additionally, the invention also includes a virtual button that facilitates multilingual support. The “Language” virtual button 115, when selected, displays a “pop-up” window that has a listing of all supported languages which, when selected, converts all of the text and audio segments on the display to that language. As will be appreciated by those having skill in the art, this multilingual directory capability is a unique market innovation that can significantly increase the value of the system to property owners and, as a result, the practical market value of the invention. In addition, when coupled to a videophone-based multilingual customer service center, the system can support live communications in the user's native language.

Additionally, the invention includes a content security scheme that provides for eliminating unauthorized content being transferred to the system from the network or loaded from the local input/output ports of the PC located within the housing. Network-side security is facilitated by incorporating firewall and triple-DES encryption technologies similar to various forms of commercially available product and configuring each system to only recognize valid encrypted data traffic. Although the traffic itself is not particularly sensitive material, requiring all traffic to be encrypted allows each system to effectively ignore all other traffic and only facilitate communications with traffic that is properly encrypted. This has the effect of eliminating all currently known hacking methodologies devised to gain access to or disable a computer connected to a network. The only way to gain access to the system from the network is to use the valid encryption key, and “cracking the code” would take several Cray mainframe computers several years to accomplish. By modifying the encryption key every few months, the system becomes impenetrable to unauthorized content from the network. The local input/output ports can be disabled through the system BIOS, providing for a secure system from both the network and local access points.

This issue of content security is particularly important within public spaces of commercial buildings in that offensive or controversial content (such as pornography, for example) displayed on such a system could have severe negative commercial effects and potentially force the removal of some or all systems even with a single well-publicized event.

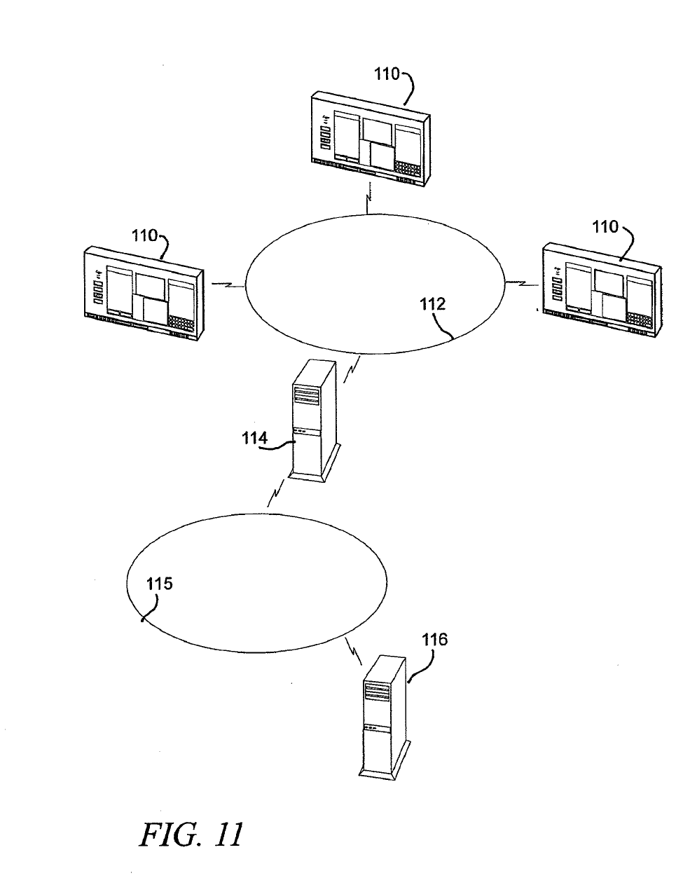

Systems of this type are contemplated as being employed throughout the public spaces of a building, campus or cluster, and are intended to be coupled together over a local area network (LAN) as illustrated in the exemplary embodiment of FIG. 11. One such system might be implemented in the lobby of a particular commercial building, while other systems might be facilitated on a sufficiently large wall space on each floor in the region of the elevator core. In a campus or cluster environment, each of the buildings might incorporate such a system in their respective lobby spaces, as well as on each floor, but might also have several systems distributed about the open common spaces of the campus or cluster, in a “kiosk” type configuration. Each of the systems will incorporate a 42-inch class plasma display (or larger) having a 16×9 aspect ratio screen and will further include an embedded PC with all of the additional communications circuitry required to link that local PC/display system into a LAN. In the exemplary embodiment of FIG. 11, each of the local PC/display systems are indicated at 110 and are coupled by a network connection 112 to a building, campus or cluster LAN server 114. The LAN server 114 is intended to function as a communication interface between the LAN 112 and a wide area network, such as the World Wide Web or Internet 115, which might be coupled to additional LANs through additional LAN servers 116, or a dedicated WAN server. It is, of course, axiomatic that the wide area network might indeed by some other form of communication internet and might not necessarily be the World Wide Web. However, because the World Wide Web is so pervasive, and its communication protocols are so well understood, the LAN server 114 is contemplated as coupling thereto and communicating therewith.

The LAN server 114 is also intended as hosting the various databases which contain the information to be displayed whenever a user invokes any one of the various functional capabilities of any one of the local PC/display systems 110 distributed throughout an installation. As will be appreciated by those having skill in the art, information contained in such a database can be quite easily modified or updated, in order to reflect changes in any particular building's occupancy or changes to the scope and location of various building amenities and services. Since the system is database driven, a system administrator need only obtain update information from either a proposed new advertiser or from building management services in order to define up-to-date and real-time changes to displayed information. Since the system is configured in a LAN/WAN architecture, any proposed additions or modifications to display information may be provided to the system administrator by communicating with the system administrator over the World Wide Web. New content could be produced by a third-party provider, and delivered to the system administrator over an Internet connection. The system administrator need only receive the file and queue the file in accordance with an agreed schedule in order for that new advertising content to be displayed in the media window at the appropriate time.

Further, and as was suggested in the discussion above, the LAN server 114 might be configured to host the entire application layer of the inventive system for the entire building, campus or cluster, with the local PC/display systems hosting primarily their adaptation of a presentation layer or client interface. Certain of the local PC/display systems might be configured to omit building community services or have their videophone capabilities truncated or even removed. For example, systems deployed in the elevator core of a high-rise commercial office building might only need to incorporate building directory and building information capability, since that confined area might be considered inappropriate for supporting two-way videophone interaction.

Further, the local PC/display systems need not all be implemented as 42-inch class displays. Depending on where a system is deployed, a smaller screen could be just as suitable for tight, confined spaces. In this particular instance, the size of the graphics and any textual information displayed will need to conform to the particular visual acuity requirements of the installation. Thus, the amount of information that might be contained in any one screen component might be less than the information contained in a corresponding screen component on a larger display. In this circumstance, a local presentation layer or client interface, hosted on each local PC/display system 110 is able to adaptively reconfigure the content information provided to it by the LAN server 114 so as to appropriately populate a display component with scroll bars, drop-down menus, or the like, in order to ensure that a user has access to all of the information capable of being displayed by that functional component.

From the foregoing description of the exemplary embodiments of the invention, it will be appreciated by those having skill in the art that various other architectures, implementations and modalities of the present invention could be developed by making various changes and modifications to the exemplary embodiments set forth herein. Accordingly, it is certainly within the contemplation of the present invention that all such changes, modifications and adaptations are included within the scope and spirit of the present invention. By way of example, the various systems described above can be coupled together by a variety of LAN architectures and by a variety of transport media, including twisted copper pair wires, fiber-optic cables, coaxial cables, RF and I/R wireless communication technologies, and the like. Even though the local area network architecture has been described above in connection with 10/100 Base T technology, it should be understood that many applications will find appropriate use of asymmetrical digital subscriber line (ADSL) technology as a LAN. Thus, how the systems are coupled together into a network and how that network is coupled to a larger or wide area network is nothing more than a design choice or option. All that is required, is that the systems be coupled together by a network technology capable of supporting at least 30 frame per second two-way videographic telecommunication, for one or more display system.

Accordingly, the invention is not to be limited to the features, aspects and embodiments described above, but rather by the scope of the appended claims.

What is claimed is:

1. A large-format display system comprising:
an integrated touch panel; and
a thin, self-contained display unit having an approximate length, approximate width, and approximate depth, the display unit including
a housing, and
a large-screen digital flat panel-type video display comprising about 40 inches or more measured diagonally across the video display, wherein the touch panel is dimensioned to fit the video display.

2. The display system of claim 1, wherein said touch panel is located substantially within said housing.

3. The display system of claim 1, wherein the video display comprises a plasma type video display.

4. The display system of claim 1, wherein the housing protrudes no more than about 4.0 inches from a mounting surface.

5. The display system of claim 1, further comprising a computing device in communication with the video display, the computing device configured to execute software instructions which cause a display of building directory information.

6. The display system of claim 5, wherein said software instructions cause an interactive display of said building directory information.

7. The display system of claim 1, further comprising a computing device in communication with the video display, the computing device configured to execute software instructions which cause a display of advertising content.

8. The display system of claim 7, wherein said software instructions cause an interactive display of said advertising content.

9. The display system of claim 7, wherein a majority of said video display displays said display of said advertising content.

10. The display system of claim 9, wherein said majority occurs when said video display operates in a default mode.

11. The display system of claim 10, wherein said default mode comprises a state entered when users have not activated said touch panel for a predetermined period of time.

12. The display system of claim 1 adapted for a public space environment.

13. The display system of claim 1 adapted for a commercial environment.

14. The display system of claim 1, wherein the housing protrudes no more than about 4.0 inches from a mounting surface.

15. An interactive large-format display system comprising:
a thin, self-contained display unit having an approximate length, approximate width, and approximate depth, the display unit including
a housing, and
a large-screen digital flat panel-type video display comprising at least about 40 inches measured diagonally across the video display; and
a computer device, said computer device including
a digital video output, and
digital video interface electronics capable of translating the digital video output to a digital format suitable for interfacing to said video display.

16. The display system of claim 15, wherein the video display comprises a plasma type video display.

17. An ADA-compliant large-format display system comprising a thin, self-contained display unit having an approximate length, approximate width, and approximate depth, the display unit including a housing which protrudes no more than about 4.0 inches from a mounting surface, and a large-screen digital flat panel-type video display comprising about 40 inches or more measured diagonally across the video display.

18. The display system of claim 17, comprising a computer associated with said housing without increasing the approximate length, approximate width and approximate depth dimensions of said housing

19. The display system of claim 18, further comprising a touch panel dimensioned to fit the video display, said touch panel, said computer and said housing protruding no more than said about 4.0 inches.

20. A method of interactively presenting information including one or more of concierge information, building directory information and advertising content on a large-format display system, the method comprising:
providing interactive information on a thin, self-contained display unit having an approximate length, approximate width, and approximate depth, the display unit including a housing, and a large-screen digital flat panel-type video display comprising about 40 inches or more measured diagonally across the video display
receiving user interaction with said interactive information through an integrated touch panel dimensioned to fit the video display.

21. The method of claim 20, wherein said providing comprises providing said interactive information in a public space environment.

22. The method of claim 20, wherein said providing comprises providing said interactive information in a commercial environment.

23. The method of claim 22, wherein providing interactive information comprises providing building directory information.
